(19) United States
(12) Patent Application Publication
(10) Pub. No.: US 2009/0037451 A1
(43) Pub. Date: Feb. 5, 2009

(54) Attack and Disaster Resilient Cellular Storage Systems and Methods

(75) Inventor: Paul L. Borrill, Palo Alto, CA (US)

Correspondence Address: FISH & RICHARDSON P.C., PO BOX 1022, MINNEAPOLIS, MN, 55440-1022, US

(73) Assignee: REPLICUS SOFTWARE CORPORATION, Palo Alto, CA (US)

(21) Appl. No.: 12/162,121

(22) PCT Filed: Jan. 24, 2007
(86) PCT No.: PCT/US2007/061003

§ 371 Date: Jul. 24, 2008

Related U.S. Application Data
(60) Provisional application No. 60/762,286, filed on Jan. 25, 2006.

(51) Int. Cl. G06F 17/30

(52) U.S. Cl. 707/101; 707/102; 707/E17.009

(57) ABSTRACT

Systems, methods, and apparatus for providing data storage services storage using self-organizing replica management. In one embodiment, a cellular system operates storage objects, for example, data files, for clients. The system stores the storage objects as generally more than one substitutable replica, with each replica being stored on a separate cell. In some aspects, the system maintains multiple layers of overlapping trees and uses them for managing storage object replicas. In other aspects, a single self specializing substitutable cell performs dynamic specialization of itself in the system, while persistence is provided by the system as a whole. In other aspects, the system gives replicas special status while their storage object is being updated and returns them to a state of being fully substitutable after all changes have been successfully propagated to the replicas.

### BACKGROUND

The present invention relates to the distributed storage of data objects, for example, files of a conventional file system, for example, an NFS (Network File System) or CTFS (Common Internet File System) file system.

### SUMMARY

This specification describes cellular systems, and methods performed the systems, that provide data storage services using self-organizing replica management. The systems operate to store storage objects, for example, data files, for clients. The systems store the storage objects as generally more than one substitutable replica, each replica being stored on a separate cell.

In one aspect, the systems maintain multiple layers of overlapping trees and use them for managing storage object replicas.

In another aspect, a single self-specializing substitutable cell performs dynamic specialization of itself in a cellular storage system, while persistence is provided by the system as a whole.

In another aspect, the system gives replicas special status while their storage object is being updated and returns them to a state of being fully substitutable after all changes have been successfully propagated to the replicas.

The technology, including the data storage systems, apparatus, methods, and programs, described in this specification can be implemented to realize one or more of the following advantages. The technology can be used to create an enterprise class digital storage system that has minimal operational complexity, including minimal need for human intervention. An indefinite number of cells can be managed as a single system. Cellular storage combines the routing and cells in a single unit of storage. The system is self-organizing on a recursive, near-neighbor basis. Neither global knowledge nor third party systems are required to invoke the protection, recovery or migration capabilities; these capabilities are implicit, simple, and scalable.

Systems become more robust as they grow in size. One or many cells or links can fail at once, and the system can still deliver its service from the remaining cells and links. There are no centralized or specialized storage systems or subsystems to be managed independently. The self-healing capability of the cellular storage fabric is basically reliable, secure, and automatic.

The performance of a cell is the same as the performance of a high quality server based on the same hardware. Clients experience direct local performance with their cells on local replicas, without the slowdown of having to go through another device or switch. The intrinsic dynamic locality mechanisms, which are responsible for replica distribution and on-going migration, ensure that, most of the time, replicas are local to where they are most likely to be used next.

Cellular storage is easily distributed. Multiple cells can be combined into cliques, and cliques can be distributed to an indefinite number of sites, that is, cliques do not need be tied to data centers. This supports a lower latency experience for client applications and users, and makes the system well suited for use in remote office consolidation.

The system balances capacity and bandwidth. It presents a replica management system, which provides implicit backup and intrinsic disaster immunity. This allows storage objects, e.g., client files, on the system to use variable amounts of storage and bandwidth resources, based on the business value of the data, on a per file or per directory basis.

User or administrator file settings allow replicas to be maintained to provide particular classes of data protection, offering a storage service for data ranging from temporary and replaceable, on one extreme, to mission critical, on the other.

The details of one or more embodiments of the invention are set forth in the accompanying drawings and the description below. Other features and advantages of the invention will become apparent from the description, the drawings, and the claims.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 illustrates a set of substitutable and nominally identical storage cells in accordance with the invention.

FIG. 2 illustrates an implementation of an example cell.

FIG. 3 illustrates the software architecture of one implementation of a cell.

FIG. 4 is a flow chart of a method performed by each cell in one implementation of a cellular storage system when the cell starts up.

FIG. 5A shows an example method of a startup process for cells to organize themselves a clique.

FIG. 5B illustrates an example latency minimized spanning tree for a cell in a clique.

FIG. 6 illustrates example cell trees across multiple cliques.

FIG. 7 is a flow chart of an example process that may be performed to create a cell tree.

FIG. 8 illustrates a routing table for a cell in one implementation of a cellular storage system.

FIG. 9 is an example of a dynamic locality handle tree built upon a cell tree.

FIG. 10 illustrates the principles of replica management on storage cells.

FIG. 11 illustrates an example of a dynamic locality handle tree, as shown in FIG. 9, overlaid with a metadata tree.

FIG. 12 illustrates a multilevel tree structure used in a cellular storage system.

FIG. 13 illustrates a number of cliques that form a colony.

Like reference numbers and designations in the various drawings indicate like elements.

### DETAILED DESCRIPTION

This specification describes a data storage architecture based on substitutable storage cells, complete storage systems formed from the distribution and aggregation of such cells, and implementations of such cells.

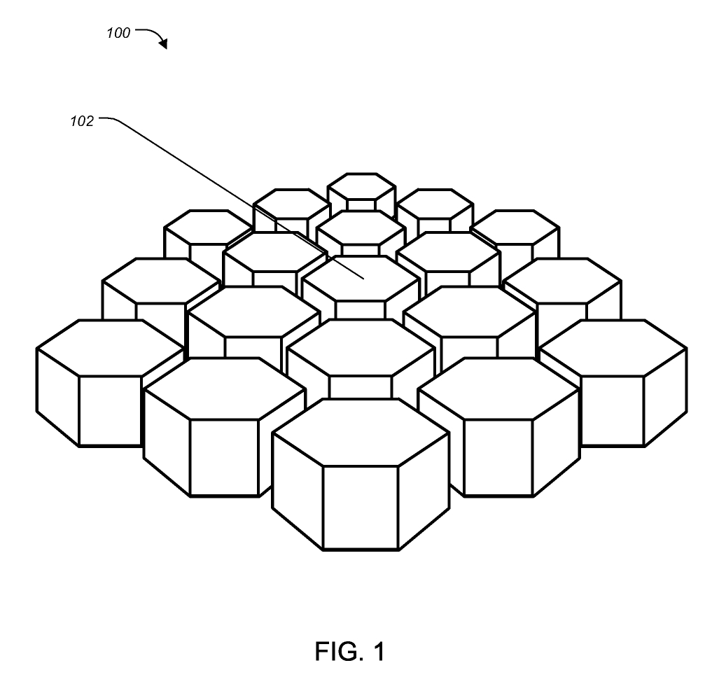

FIG. 1 illustrates a set of substitutable and nominally identical modular storage elements or network-attached storage (NAS) cells 100, any one of which may be referred to as a cell, e.g., cell 102. Such cells are building blocks of a cellular storage system, as will be described. Each cell behaves as an individual, substitutable component. It is a bounded entity that includes hardware and software. Each cell may be implemented as a single board computer that includes a processor, a random access memory, storage devices and one or more external port connections. Also included in the cell is specialized system software to operate the cell within a cellular data storage system.

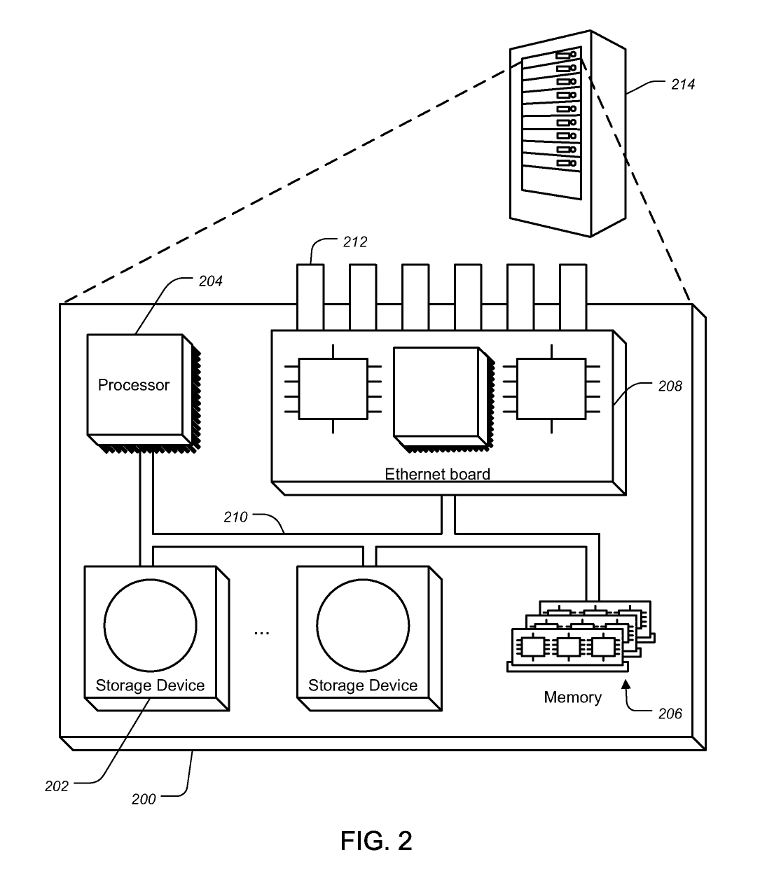

FIG. 2 illustrates an implementation of an example cell 200. The cell 200 is constructed with commodity hardware, in this example a single board computer. The cell 200 includes two or more high capacity disk drives 202, a processor 204, memory 206 and an Ethernet controller 208 with multiple ports. The processor 204 runs specialized system software, which is pre-installed on the cell, for example, at the time of cell manufacture, which operates and controls the hardware of the cell as well as its behavior as an autonomous agent within the cellular storage system. The processor 204 as well as other system components uses the memory 206 in the execution of the system software. One or more busses, e.g., bus 210, connect the system components allowing data exchange and communication. The Ethernet controller 208 may provide, for example, six substitutable 1 Gbit or 10 Gbit Ethernet ports, e.g., port 212. The cell 200 thus has multiple physical network interfaces that may each be physically connected to another cell, e.g., a local peer cell. The connection may be made, for example, with an Ethernet cable by connecting the Ethernet ports of two cells to each other. A cell may be directly connected to a remotely located cell as well, for example, through a router and virtual private network (VPN) connection. For local cell-to-cell communication, cells are not connected to each other through switches, so the maximum number of cells that can be directly connected to any particular cell is the number of ports it has. This physical connection or “valency” constraint is useful in that it facilitates the building of self-organizing systems.

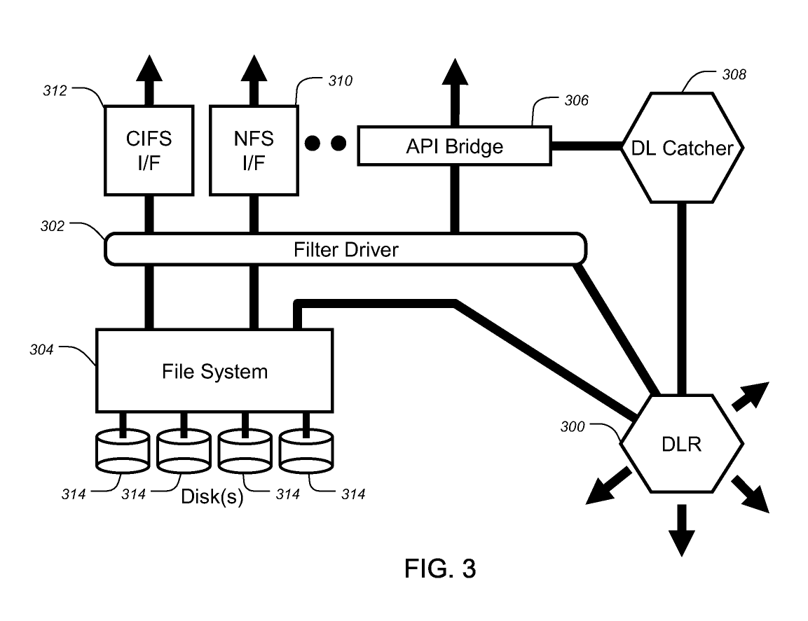

FIG. 3 illustrates the software architecture of one implementation of a cell. The architecture includes a dynamic locality router 300, a filter driver 302, a local file system 304, a cell API bridge 306, and a dynamic locality catcher 308.

The dynamic locality router (DLR) 300 is typically implemented as kernel code. It provides the low-level or core functionality that determines the behavior of the cell. The DLR receives and transmits data on one or more physical and logical interfaces which connect to other devices on the network, including other cells. The DLR contains all the machinery and routing tables necessary to perform the routing function of a cell.

The other software components contain the machinery that provides services for local user workstations and servers connected to the cell, and for a local administration interface. Operations on the local administration interface are propagated globally, so that the cellular storage system may be managed from any cell.

Packets that are received on one interface by the DLR may be immediately routed and transmitted by the DLR on one or more other ports, without any communication with other software components in the cell. This allows for a storage object routing function that can transmit large replicas wormhole style, where the first part of a replica is retransmitted on another interface before the whole replica is received.

The filter driver 302 is a layer implemented as application code. The filter driver is a layer (a collection of code that interacts with other layers/code only according to well-defined interfaces) that receives file system client requests over some conventional channel (e.g., CIFS (312), NFS (310), HTTP or FTP over TCP/IP), translates them into operations on storage objects, receives the results of such operations, translates them into the appropriate actions in the local file system, and sends them to the requesting client over the originating channel. The file system can be any commonly used file system associated with the operating system, ideally a transaction-oriented or journaled file system for optimum reliability and failure indication characteristics.

In one implementation, the filter driver remains transparent to messages being transmitted from the network file protocols, e.g., NFS or CIFS, to the local file system, until such time as the local file system of the cell responds with a “file not found” message. The filter driver captures this message and uses the DLR to locate and retrieve a replica of the file requested, placing it in the local file system, before “repeating” the operation requested by the user, thereby appearing transparent to the user with a minor time delay as the replica is retrieved from other cells on the network.

The local file system 304 manages the storage of storage objects, e.g., replicas, on disks 314.

The cell API bridge 306 is application level code that provides an interface to the storage cell API, which can be used by other computers which are aware of the cellular storage functionality. For example, the bridge may be used to provide an interface for an administration console.

The dynamic locality catcher 308 is application level code that provides the high level functionality which determines the behavior of the cell, i.e., that functionality which does not need to be implemented as a routing function, including initialization of the DLR, discovery of other cells, configuration of the cell, and adaptive responses to and recovery from failures.

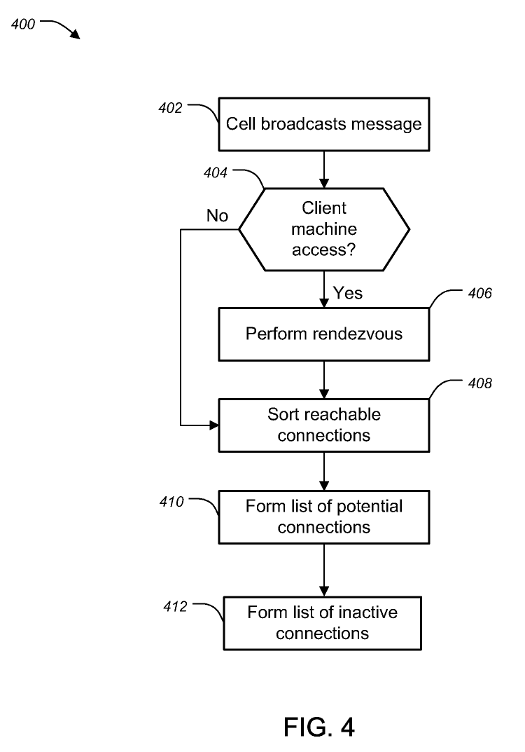

FIG. 4 is a flow chart of a method 400 performed by each cell in one implementation of a cellular storage system when the cell starts up. The initiating cell broadcasts a message over each of its ports identifying itself as an initiating cell (step 402). On each port, the cell can receive one of a number of responses: It can receive a response from a single cell identifying itself as a cell; it can receive responses from more than one cell, each identifying itself as a cell; or it can receive a response from a router indicating that the router is connected to the port, along with responses from any number of devices (including zero), each identifying itself as a cell or some other network device.

The cell also attempts to determine whether it can be accessed by client machines (step 404). In one implementation, it does this by sending out a DHCP (Dynamic Host Configuration Protocol) message on each port asking for an IP address. If it receives one, it assumes it can be accessed by clients over the corresponding port.

Once the cell has determined that it is connected to a router, it performs a rendezvous process (e.g., sending an IP multicast to a well-known multicast address, using a DDNS (Dynamic Domain Name System), or posting and reviewing entries on a UDDI (Universal Description, Discovery and Integration) bulletin board) to discover any other cells that are accessible over the router (step 406).

A cell will identify itself as being a core cell if on each port it only receives no more than a single response from a single other cell.

If a cell receives on one port responses from more than one cell, each identifying itself as a cell, then the cell infers that it is connected to a switch or a router, and it will identify itself as being an edge cell. If a cell determines in any other way that it is connected to a router, it will also identify itself as being an edge cell.

If a cell determines that it can be accessed by a client device, e.g., because it received an IP address in response to a DHCP request, it identifies itself as a client-accessible edge cell. If during the rendezvous process it discovers another clique through the router, it will specialize itself to be a proxy cell and connect to the other remote clique.

In an alternative implementation, a cell determines its attributes by performing the following startup operations for each port on the cell. First, the cell determines whether the port is connected to another port on the same cell. If it is, it is likely a cabling error and the two ports are made inactive. Then, the cell determines whether the port is connected to another device that is not another cell. The other device might be a client device, e.g., a personal computer, or it might be a router, which is distinguished from a switch in that a router does address translation. The connection to a client device can be direct or through a switch. In one implementation, if the cell is connected to either a client device or a router, the cell gives itself the attribute of a being an edge cell. The cell also determines whether it is connected to a DHCP server or otherwise can obtain an externally supplied IP address. In either case, the cell gives itself the attribute of being an edge cell. The cell also determines whether it is connected to potential client devices, directly or otherwise. If it is, the cell gives itself the attribute of a being client accessible cell. The cell also determines whether is connected through a router to a network where remote cliques may exist. If it is, the cell performs a rendezvous operation and forms connections with one or more of the remote cliques. The cell also gives itself the attribute of being a proxy cell and acts as a proxy for the clique of which it is a member with respect to other cliques.

If after all the ports have been considered as just described, the cell does not have the attribute of being an edge cell, it gives itself the attribute of being a core cell. The attributes of core and edge are mutually exclusive.

Cells adaptively specialize themselves according to how they discover themselves to be connected to other cells and non-cell network resources. An edge cell that finds itself connected to user workstations or servers, for example, may adaptively specialize itself for optimum response latency and bandwidth qualities. Such connected devices and systems will be referred to generically as clients, because they are clients of the storage system. In another example, a core cell, a cell that finds itself connected only to other cells, will specialize for optimum qualities of persistence.

Cells may adapt themselves by adjusting their parameters in response to attributes acquired during the discovery process or in response to events in the network, such as cells joining or leaving the resiliency web. The union of all the cells and connections between cells (whether directly or through a switch or router) will be referred to as the resiliency web of the cellular storage system.

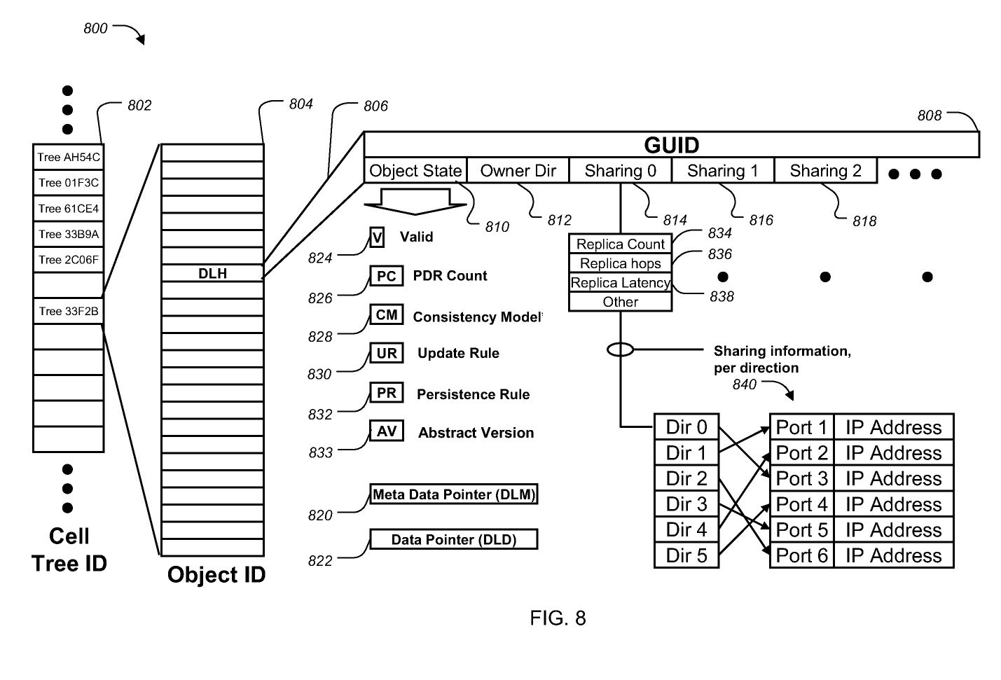

For example, core cells may adapt to using most of their memory for routing and persistence functions, whereas edge cells may adapt themselves to using most of their memory for communication with client devices and remote cliques. Core cells generally do not need access to the metadata of a file because they are able to manage their set of replicas using the machine readable handles of the files only, whereas edge cells may need the metadata in order to relate the storage object to a position in an abstract hierarchical directory that can be identified and manipulated by users on clients. This will be described further in reference to FIG. 8.

In one implementation of a cellular storage system, all of the connections of the resiliency web are used by the system. In an alternative implementation, the number of active connections for any one cell is limited in order to simplify the working topology of the system. The limit for any one cell will be referred to as its valency. The valency can be implemented as a global parameter or as a parameter specific to each specialized kind of cell (e.g., core cell, client-accessible edge cell, and so on). A cell can also set its valency based on the presence of relative data storage capacity or communication bandwidth in that cell.

If valency is in effect, each cell sorts its connections into connection latency order from the smallest latency to largest (step 408). If the number of actual operating connections is greater than the valency, the cell then selects the top valency-number of connections as its active connections (step 410), and renders the remaining connections inactive (step 412). Inactive connections are kept in standby mode in case they are needed to heal the system when active connections fail.

Cells that are locally connected to each other can recursively identify themselves as a clique as part of their start up process. In one implementation of the system, every clique is connected behind a router. In such a system, a clique is a cluster of cells located together in one or more recursively connected subnets behind a router. The router may connect the clique only to other cliques, or it may connect the clique to devices external to the cellular storage system such as client devices.

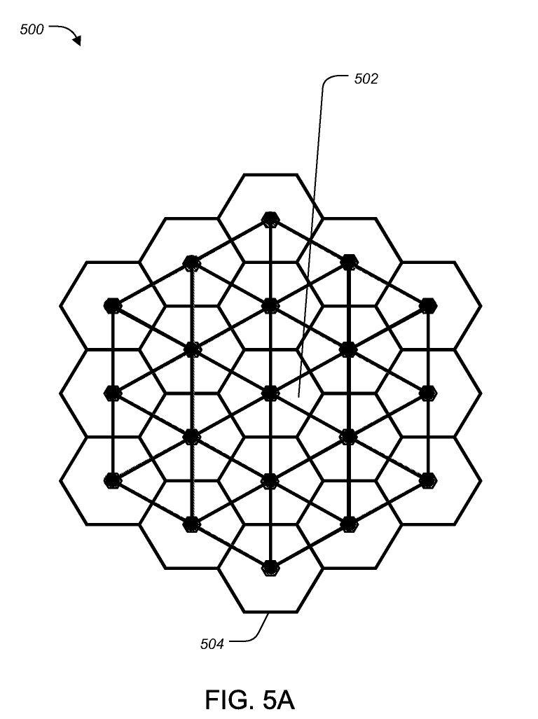

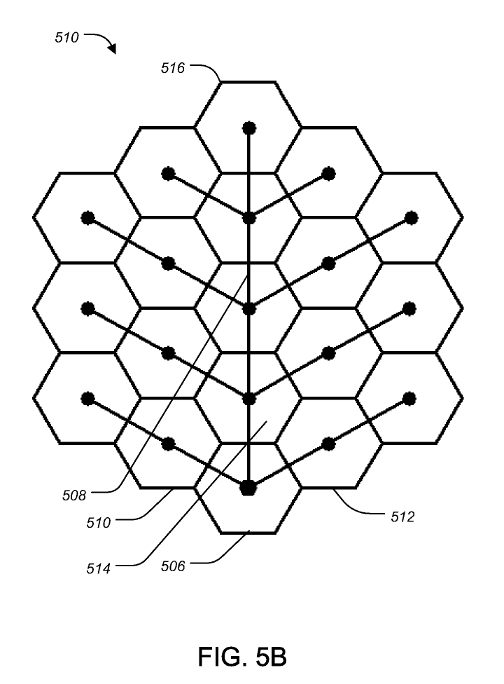

FIG. 5A shows an example method of a startup process for cells to organize themselves into one or more cliques in such a system. The formation of the clique 500, in this example, begins with cell 502 discovering other nearby cells in its subnet. Cells join the clique one at a time, by sending a request to join message to other cells in the subnet as a broadcast on each port of the cell.

As the clique builds, each cell extends the clique as it discovers other nearby cells. This process will continue until a cell, in its attempt to extend the cell tree, receives more than one reply per port or receives a response from a router. The cell receiving this reply will characterize itself as an edge cell, e.g., cell 504, and will no longer continue the process of extending the clique. The first cell to do so will generate a unique name for the clique and pass back a packet through the clique to identify the cells that are members. The clique is formed of cells that see one or more routers connected to edge cells plus all the recursively connected cells behind them as a single cluster of cells continuously connected through point to point connections.

FIG. 5B illustrates an example latency minimized spanning cell tree 508 in a clique. An initiating cell, e.g., cell 506, provides information about itself to other cells in the clique through a file it publishes on its own tree. In this example, the initiating cell is an edge cell connected to a router. The initiating cell owns the tree 508. The file is published on all of the ports of the cell indicating that it is connected to a router and to cells 510, 512 and 514. In turn each cell in the clique publishes a file on all of its ports indicating its connectivity within the cell tree for the clique.

In the context of the latency minimized spanning cell tree, a leaf cell, e.g., cell 516, is a core cell that is connected to the cell tree on a single port. It is located the farthest away from the initiating cell. In specializing itself to perform particular functions, a cell can identify itself as a leaf cell for particular cell trees, and can specialize itself for use as a storage cell for infrequently used storage objects on those trees.

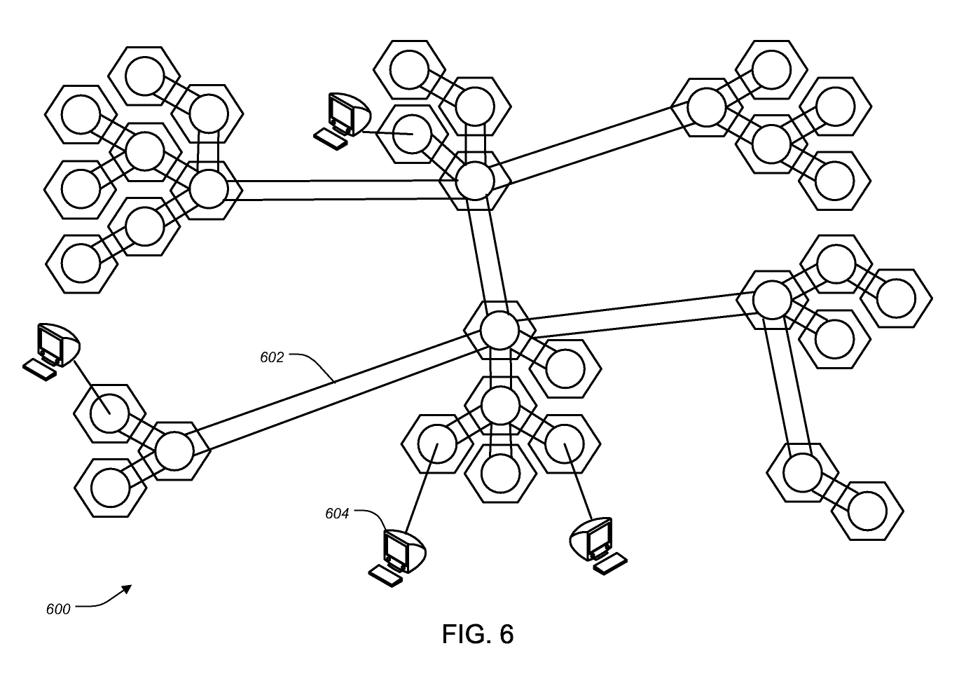

FIG. 6 shows an example cell tree 600 spanning a cellular storage system with multiple cliques. Seven such cliques are indicated in this figure; these are formed by recognizing long versus short ping latency and identifying a boundary between near and far cells based on dislocations in latency along the paths. Cell trees are built on top of the resiliency web, described in reference to FIG. 4, or the web of active connections, if valency is in effect. The cell trees span the entire cellular storage system and are a connection of latency minimized spanning trees for each clique. The cliques are connected edge cell to edge cell by way of a router and a general network. Cliques exhibit behavior similar to cells in that they limit the number of other cliques they can connect to limiting topological complexity. The cell trees are used to build and maintain a causal network in the dynamic locality design as described in reference to FIG. 3.

Cell trees are also used as routing pathways 602 for the migration of storage object replicas and other information throughout the cellular storage system. Storage object replicas, which will be referred to simply as replicas, are copies of storage objects that exist on cells in the cellular storage system. Cell trees are used by the system to provide an in-order delivery of packets from any cell on the tree to any other cell on the tree. The acyclic property of a cell tree is maintained by healing mechanisms through failures and dynamic reconfigurations of the cellular storage system. Therefore, the system can present a reliable causal network abstraction to the cell functions and user applications, for example, applications operating on a user device 604. Cell trees are metastable entities representing a pre-allocated and reliably maintained structure on which sub-trees of various types can be overlaid but which are held in a dynamic tension, ready to snap over to a new configuration as failures occur.

In one implementation, the cell tree spans all the cells in the cellular storage system.

In another implementation, the cell tree spans only the clique for all cells within the clique, except for the edge cell that is specialized as a client accessible cell or a proxy cell which now behaves as an initiating cell, on behalf of the clique, to generate trees connecting the other cliques in the system. In this latter implementation, the system has a recursive nature in which cliques can act like cells in generating trees of cliques, and colonies can act like cliques, and generate trees of colonies, and so on. At each level, the rules are the same-identify the reachable entities, form a resiliency web, build trees on them to act as a substrate for file tree sets to be built later as files are created and updated.

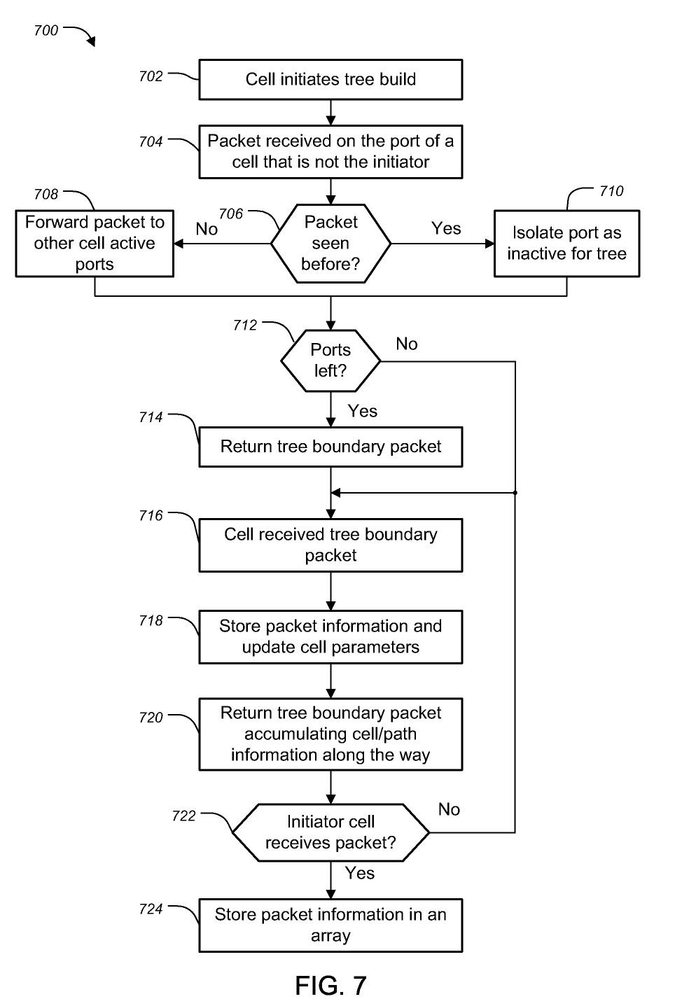

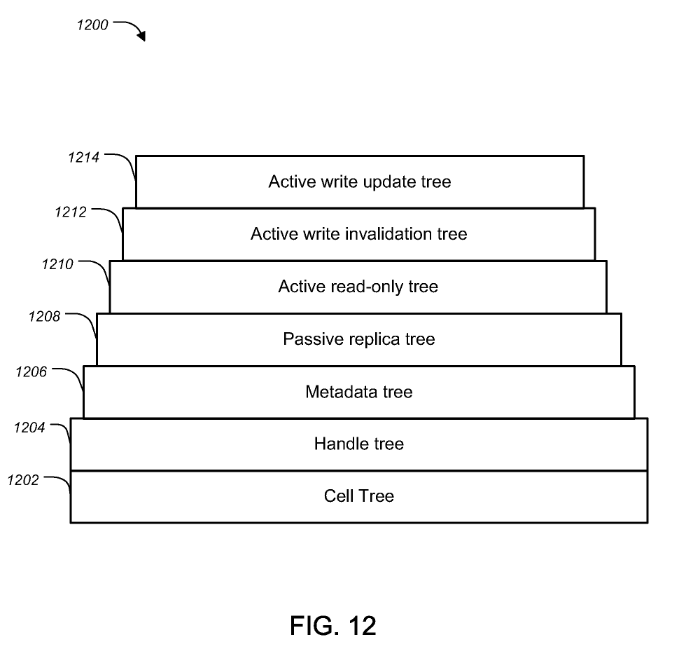

FIG. 7 is a flow chart of an example process 700 that may be performed to create a cell tree. Each cell performs this process therefore each cell is an initiator cell for its own tree. The process starts during the initial startup of a cell. This process occurs only in the cell tree layer of a multilevel stackable tree structure that will be described in more detail in reference to FIG. 12. Briefly, in this structure, higher level trees are tied into the data structure of lower level trees, and are mapped exactly on top of them as subsets, i.e., higher level trees may be pruned versions of (i.e., span fewer cells than) lower level trees.

The cell sends a tree_build packet out on all active ports (step 702). The cell that sends the tree_build packet is the initiating cell for that particular tree. When any cell receives a tree_build packet (step 704), it determines whether it has seen the tree_build packet before (step 706), and if it has not, the tree_build packet is forwarded to all active ports on the cell except the port it came in on (step 708). If the cell determines that the packet has been seen before, the cell marks and isolates the port the packet came in on as inactive for that tree (step 710), in effect pruning the graph of connections to remove cycles. Next, the cell determines whether it has any active ports on which to forward the tree_build packet (step 712). If no, the cell is a leaf cell because it received the packet on its only active port. Therefore, the process continues to step 716. If yes, the cell returns a tree_boundary packet back along the receiving path to the initiating cell (step 714). When the cell along the receiving path receives a tree_boundary packet (step 716), the cell stores the information contained in the packet (step 718). The cell also increments a hop count, a number representing the number of cells that are between the receiving cell and the edge cell on the present branch of the present tree. The cell also adds its ping latency to a path latency parameter, which is stored on the cell with the tree_boundary packet information. In this way, cell and path information may be accumulated along the way to provide hints for upper layer functions in the cellular storage system

Next, the cell passes the packet along the receiving path to the next cell (step 720). If the receiving cell is the initiating cell for the present tree (step 722), i.e., for the tree that is the subject of the packet, the initiating cell retains all of the data from the tree_boundary packet (step 724). This data will contain the maximum number of hops to the edge cell that sent the tree_boundary packet from the initiating cell and the total path latency from the initiating cell to that edge cell. The initiating cell will store this data for use by higher layers in the tree structure of the cellular storage system. If the cell receiving the tree_boundary packet information is not an initiating cell (step 722) the process proceeds to step 716.

FIG. 8 illustrates a routing table 800 for a cell in one implementation of a cellular storage system. The routing table 800 includes information about each of the trees that pass through the cell. This information includes a cell tree ID list 802 and an object ID list 804. The cell tree ID list 802 is a list of trees passing through the cell. The object ID list 804 is associated with each cell tree ID entry and is a list of storage objects per tree. The object IDs include dynamic locality handles (DLH) 806. The DLH identifies a storage object, e.g., a file, uniquely. It is a minimal data structure that specifies the current state of the replica of the storage object and its relation to all other replicas in the system down the valency-constrained paths radiating from that cell.

A DLH can be implemented as a fixed-size (e.g., 32- or 64-byte) data structure. It includes and is uniquely identified by a globally unique identifier (GUID) 808, an object state 810, an owner direction 812, multiple sharing directions 814, 816 and 818, a metadata pointer (DLM) 820 and a data pointer (DLD) 822.

The GUID 808 is used to access the replica of the storage object on this cell or to reference the storage object from any cell in the cellular storage system.

The object state 810 may include other operational status and control fields, such as: a valid status for the file, 824, a persistent dynamic repository (PDR) count 826, a consistency model 828, update rules 830, a persistence rule 832, and an abstract version number 833. The valid status 824 for the replica specifies whether the DLH is a current valid handle for the storage object. The PDR count 826 represents the minimum number of replicas required for the storage object in order to maintain persistence for the storage object. The consistency model 828 is a rule specifying the consistency and correctness of the replicas of a storage object in relation to each other. The update rules 830 specify the rules for the updating of a remote replica, for example, as changes are made to the replica. The persistence rules 832 specify rules for controlling the deletion of a file, for example, delete after 24 hours or do not delete for 30 years. The abstract version number 833 specifies a high level version control parameter for the file, and is used in the recovery of previous versions of corrupted or accidentally deleted files.

The DLM 820 points to a data structure that contains all of the metadata for the storage object which is identical across all cells. This metadata, which includes creation, update and access times, as well as access control information, is independent of the metadata with the same name on the local file system, so as to preserve the identical “file” or “object” metadata across the whole system from the perspective of all users. The metadata includes the full pathname or “human readable name” of the storage object and provides a mechanism for mapping from the flat namespace of the routing table to the hierarchical namespace of the cell's file system.

The DLD 822 points to the local file system entry, which contains the replica of the storage object on the cell. The data for a replica is the conventional collection of bytes that make up a file in a conventional file system.

The owner direction 812 identifies the direction within the tree in which to find the current owner of the replica on the cell (if the consistency model requires an owner).

Multiple sharing directions 814, 816 and 818 include the direction in which to find other shared replicas of the storage object. Each sharing direction 814, for example, includes information on a replica count 834, replica hops 836, replica latency 838 and other sharing information for that direction 840. The replica count 834 is how many copies of a storage object may exist down that path. The next device along the path to a destination is referred to as a hop. The replica hops 836 indicate how many hops to the nearest replica down the path. The replica latency 838 indicates the average latency to the nearest replica down the path. The sharing information for the direction 840 includes a reference to a port number and IP address associated with that direction.

A packet coming in on a port indexes through the routing table to find the storage object that the packet is intended for. By indexing through the DLH and sharing directions, the software can identify the ports(s) that specify the owner direction, and direction of other shared replicas for that storage object. Packets are then forwarded to those destinations along those paths according to the operation indicated in the packet header.

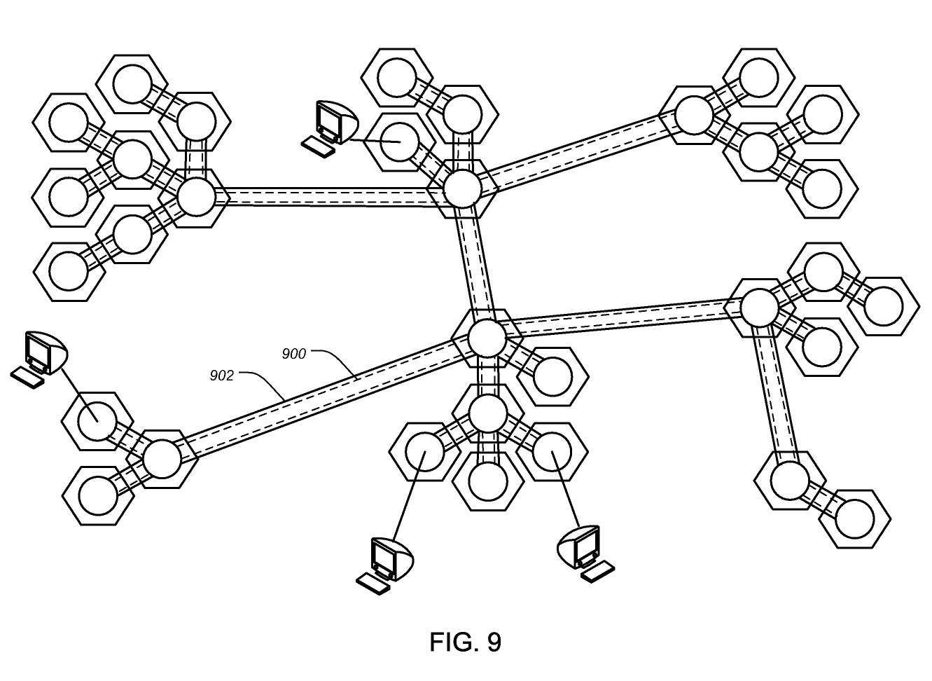

FIG. 9 is an example of a DLH tree 900 built upon a cell tree 902. A handle identifies a storage object, e.g., a file, uniquely. The DLH can be the exact same data structure used as an entry in the dynamic locality routing table for each cell. The routing table for the cell, described in reference to FIG. 8, references only the direction of the path going out of that cell (and implicitly, the address of the next device along the path to that destination, which may be referred to as the next hop). This information is available in the routing table of the cell for all reachable destinations of the cell. The DLH can also be the same data structure that is sent when a file is published to the network of the system.

The cellular storage system maintains a unified namespace based on file trees that are overlaid on the cell trees. Unlike a distributed file system, each cell maintains a completely independent file system with no relationship to other cells whatsoever, except for the connection and updates through the unified namespace (tree mechanism).

DLHs are published by cells over their own cell trees in order to create DLH trees, which are overlaid directly on top of cell trees. Each cell advertises the existence of a particular storage object, for example, a file, over the cell tree for that cell. A cell, by publishing file handles, lets other cells know how to reach a valid replica, or copy, of a storage object. It does this by installing a DLH entry into the routing table of each cell. The DLH entry acts as a “waypointer” that points to the direction in which, for example, the cell may find the current owner of the file, or other shared replicas of that file. A cell may also withdraw publication of a file handle by notifying other cells that the replica of the storage object is no longer valid. It may do this, for example, in the event of the deletion of a file as requested by a user.

If a tree breaks for any reason, for example in the event of a cell failure, then the cell tree layer, which will be described in reference to FIG. 12, is responsible for fixing the tree resulting in a local heal operation. The cell tree healing operation is leveraged by all the DLH trees built on top of the cell tree.

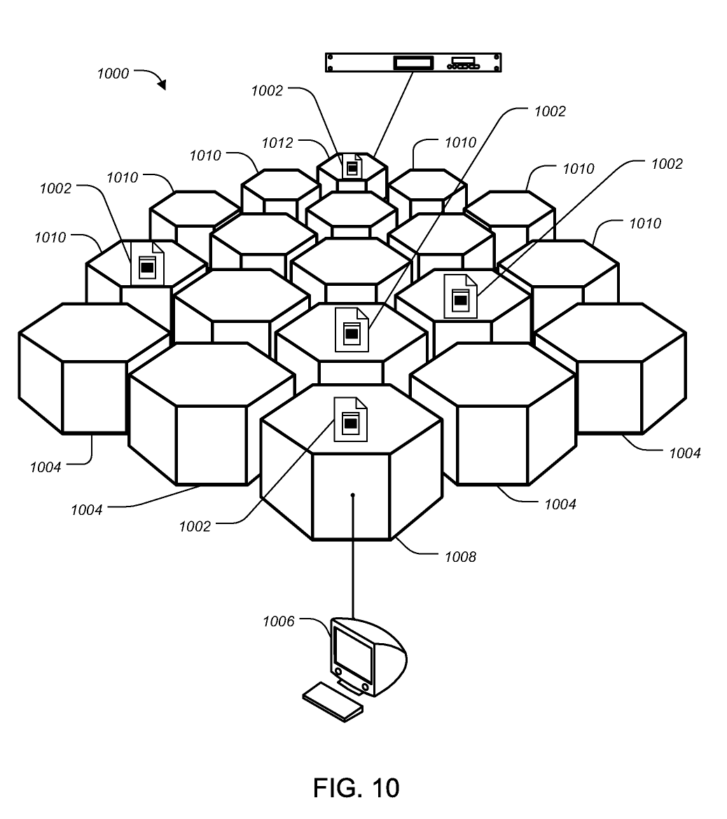

FIG. 10 illustrates the principles of replica management on storage cells 1000. Replicas 1002, appear to migrate freely among the cells (along the paths constrained by the cell tree on which that file was published) in response to user requests for access and eviction of a replica for a file that is least recently used for that cell in order to make room for newer files in cells with finite capacity. Replica migration is controlled by file migration policies. Most recently used files tend to appear on the edge cells 1004 and 1008 where clients perform file operations. The result is reduced latency in accessing files by a user, for example, operating on a device 1006 connected to edge cell 1008. Files not recently used tend to appear in cells distant from client connections, e.g., cells 1010 and 1012.

Resource management by individual cells results in an apparent general pressure on a replica to migrate away from edge cells that are filling up. Cells can also implement attractor and repulser agents that operate to cause replicas to move in particular directions. There can also be a general pressure or attraction toward cells with special archive or storage class capabilities, for example cell 1012. A flexible interface is provided in the cell software architecture described in reference to FIG. 3 to allow applications to trade off data consistency requirements in exchange for improved performance through flexible constraints on the number and spatial distribution of replicas that need to be accessed concurrently as a single file image.

When a cell reaches its maximum storage capacity threshold, it can migrate replicas to other, near neighbor cells. A level-seeking algorithm determines whether or not cells down each particular path may have the capacity to store the replica. Adaptive thresholds for the storage capacity of a cell can be set on the cell in the cellular storage system. Threshold manipulation is a process to indirectly influence the self-organizing behavior of a cellular storage system, without directly trying to control the migration behavior. Each cell has a low threshold, indicating that it has spare capacity it is willing to offer the rest of the cellular storage system, and a high threshold, above which it needs to push off least recently used files in order to make room for new files coming into the system. By each cell adaptively adjusting the thresholds in response to observed traffic load, or time of day, the probability of migrations can be increased or decreased. Since this uses bandwidth, a way to balance the load over the course of a day is to raise and lower those thresholds in order to migrate replicas at a time when the networks are relatively quiet, thereby saving the bandwidth for those migrations at a time when the networks are more heavily used. Cells can adjust thresholds by time of day, or adaptively in response to traffic monitoring on the network. The processes which adjust the thresholds may also communicate with and interact adaptively with the quality of service mechanisms in the customer's network

Cascaded synchrony is a process by which updates applied to a replica may be differentially propagated along a file tree, as described in reference to FIG. 12, to other replicas. Cascaded synchrony may be implemented as a parameterized rule which is executed by a process in each cell along the path of the file tree. The parameters specify how far along the file tree path, based on a cell count (e.g. 0, 1 or N cells), updates are allowed to be sent synchronously. This is followed by the next cascaded stage where updates are sent asynchronously, but with a high update frequency. In further cascaded stages, updates or invalidates are sent at a lower update frequency. In this way, local application performance can be flexibly traded off with data safety in a failure, disaster or attack resilient way. Updates sent with a high update frequency can be sent, for example, every second; and those sent with a lower frequency can be sent every 30 seconds, for example. Optionally, these frequencies can set by an administrator as system wide parameters or can be adjusted by the sending cell in response to operating conditions.

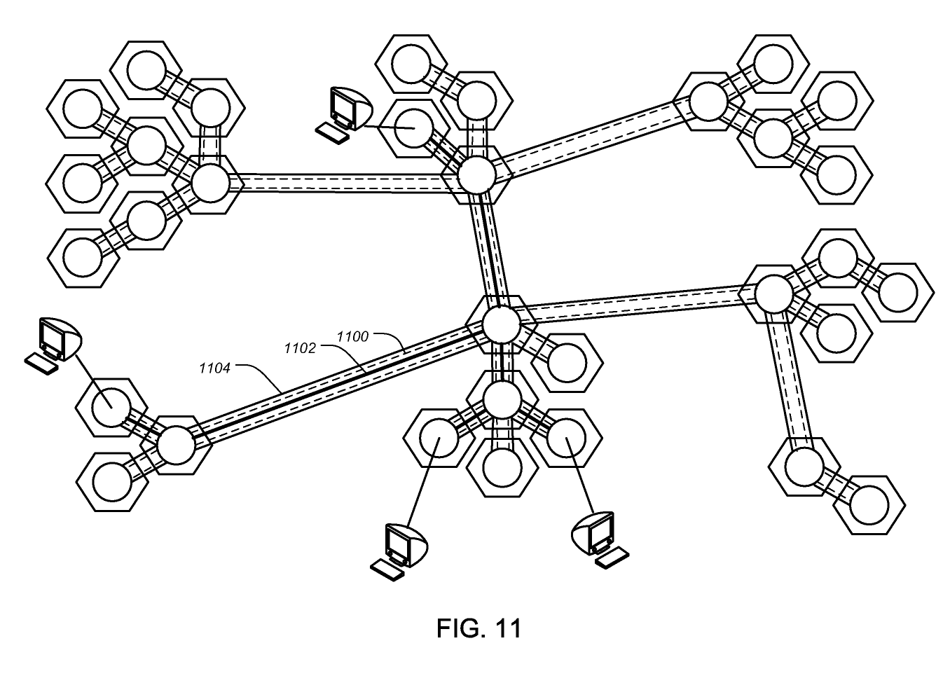

FIG. 11 illustrates an example of a DLH tree 1100 overlaid with a metadata tree 1102. The metadata tree 1102 is a subtree of the DLH tree 1100 and the cell tree 1104, which are coextensive. The cells that contain the metadata for a replica have additional information in, or associated with, the routing table for the cell as described in FIG. 8. This metadata can include the full pathname of the file used to identify where to put the file in an abstract hierarchical file system (as viewed by users). It can also include identifiers or reference pointers to the policies, rules and parameters that must be maintained for all replicas of the file.

The metadata tree 1102 and any data trees (described below) need not extend everywhere the cell tree 1104 and the DLHI 1100 tree extends. They may cover only the cells that need the additional metadata or data for that file, for example, cells that have subscribed to the file. Subscribing to a file involves the requesting agent, for example a user or application, notifying the cell that contains the file, the recipient cell, that an application wishes to obtain the metadata or data of the file. The requesting agent creates a subscribe request which lists the desires of the requesting agent. The requesting agent may, for example, desire the entire data file or a portion of the file, e.g., for sector caching. The subscribe request may show that the requesting agent desires to open the file for read-only or read-write access or a particular consistency or update model. The recipient cell for the subscribe request, which is usually the current owner of the file, may accept the request, deny the request, or offer an alternative to the parameters desired in the request. A cell may also unsubscribe to a file relinquishing all interests in the file. The subscribe operation is an event on which negotiations may occur for temporal intimacy or other characteristic behaviors of the replicas in a shared read-write application for the cellular storage system.

Temporal intimacy refers to the degree of coupling in update behavior between two or more replicas. When one replica is updated, other replicas may be updated immediately—on the write-update tree, either synchronously or asynchronously; other replicas may be notified that an update has occurred and that the replica is now invalid—on the write-invalidate tree, either synchronously or asynchronously; or the updates may be accumulated and sent only after the application program on the client exits and the file is closed.

Intermediary cells may snarf file information that passes through them if they have reason to believe that their application processes may need those files in the future. They may also snarf the file information because they have spare space that can be effectively used in assisting in the protection and localization of the data. This may reduce the potential latency and bandwidth used by additional requests to the file, which go through that cell.

FIG. 12 illustrates a multilevel tree structure 1200 used in a cellular storage system. The base is a cell tree 1202. Overlaid on the cell tree can be one or more file trees. The base file tree is a DLH tree 1204, which may also be referred to as a handle tree. File trees overlaid on top of the DLH tree are data trees. Data trees can be of two types: passive data trees and active data trees. Passive data trees include a metadata tree 1206 and a passive replica tree 1208. Active data trees include an active read-only tree 1210, an active write invalidation tree 1212 and an active write update tree 1214. Overlaid on the cell tree there can be one or more DLH trees representing different storage objects. Overlaid on each individual DLH tree 1204 is the metadata tree 1206. Data trees need to extend to only those cells that have a full copy, or replica, of the file data, whether the replica is open or not. A passive replica tree 1208 includes only of those cells where the replica is closed (inactive).

An active tree includes those cells where the data is active, e.g., an application on the cell has a file open for reading or writing. The active read-only tree 1210 connects all replicas that have the file open for read only.

The active write invalidation tree 1212 is the penultimate overlay, on top of read only trees. The active write invalidation tree 1212 connects only those cells where the data is open for read or write. When the owning cell of a file modifies its replica of a file, it sends invalidation packets to those locations on the cell tree which have not yet received an invalidate packet. Invalidate packets need to be sent once only to notify that a replica is invalid. If an application on the cell is interested in reading the file again, it must request a fresh copy of the data.

In this way, the active write invalidation tree 1212 can be pruned by the current owner of the data by sending an invalidation packet to the more remote replicas of an object, even if they are open for read, so that bandwidth may be conserved over the greater number of hops, especially those which go over WAN connections.

The active write-update tree 1214 is defined as a subset overlay for the active write invalidation tree 1212. The active write-update tree 1214 connects only those replicas on cells where the application has the file open for write and the subscription to that replica included a requirement that it send updates rather than invalidates when a write occurs. This hint may also bee provided by an application API to control dynamically the use of invalidate versus update behavior. When the owning cell of a file modifies the file, it sends updates to all the other cells on this tree, keeping them up to date. Synchronous or asynchronous updates may be chosen during the subscription, for example by the user or replica policy, to extend synchronous updates to a smaller set of replicas than the open for write set. For example, synchronous updates to a smaller set of replicas than the open for write set can be performed on only those replicas within some minimum number of hops or some minimum transmission latency from the owning cell thereby maintaining an adaptively minimized “radius of temporality”, which represents a dynamic optimum between application performance and update freshness to remote replicas.

Migration of file or replica data across multiple cells in the cellular storage system is the result of the setting up entities, called attractors and repulsers, which cause storage objects to be moved from one cell to another without the destination cell knowing the source cell, in the case of an attractor, or the source cell knowing the destination cell, in the case of a repulser. An attractor is a cell that advertises itself as interested in receiving replicas of some particular kind or of any kind. The source of the replica is unknown to the attractor cell. A repulser cell in effect pushes a replica away from itself and hence out to an unknown destination. The destination is chosen by criteria established by a policy, and verified by the mechanisms in the system. Examples of repulser actions would be pushing a replica out to at least three other cells, or pushing a replica out beyond a specific distance so as to enhance the protection of that data against various locally geographic failure scenarios, including fires, floods, earthquakes, or terrorist attacks.

Trees, attractors and repulsers are the mechanism for laying down a set of direction vectors, which may be referred to as waypointers, in the cells. An attractor, for example, may set the direction vectors in the cell. By sending out a uniquely identifying “this way” packet throughout the cell trees, attractors can set the direction vectors in each cell such that any cell can know which direction to go in to find a particular attractor. Those direction vectors are can advantageously be implemented with and integrated with the DLH tree mechanism described above.

Replica management involves the access, protection and automation of storage objects or files. All replicas of the same storage object are bound together through the distributed tree data structures in the cellular storage system. For the architecture to achieve its intended purpose, it is essential that there are no orphan replicas. All replicas belong to one connected set of replicas that represent the state of the storage object. Even for replicas that are disconnected, on the other side of a partitioned network, for example, or stored on tape, state is maintained in the routing table entries and they logically remain part of the replica set for the storage object. Metadata is bound to each replica from the moment the first replica (i.e., the original storage object or file) is created. The data follows all replicas to whatever cell they may be placed in, so that if one or more replicas become disconnected, they can easily self-identify and reconnect to their peer replicas for the storage object. The system can resynchronize disconnected replicas using one of two mechanisms. One mechanism buffers operations until the network heals. The other mechanism allows operations to proceed on the accessible replicas and uses a fast incremental file synchronization algorithm after the network heals. A suitable fast incremental is implemented in the rsync program, which is an open source utility described, i.a., at http:/samba.anu.edu.au/rsync/.

All replicas are connected in real-time or through logical offline metadata catalogs, which are implicit in the routing table entries, as described in reference to FIG. 8, in each cell. Therefore, the system can provide auditable deletion. If a file is deleted, the system never gives up, and will not return a final acknowledgement, unless all the replicas have been deleted.

All user level behavioral functions of the replicas such as caching, mirroring, backup, archive and remote replication are built on top of the replica management engine, and instructed by the user level, using predefined rules, to behave according to the prescribed functions.

Replicas of files are stored on different cells throughout the cellular storage system. Replicas may be created, deleted or migrated. A replica can be created in response a local request from a requesting agent to the cell, for example a new file command is issued on a cell. A replica can be deleted after it is marked as invalid. The deletion can occur, for example, in anticipation of other (perhaps newer) objects in the cell needing space. A replica can be migrated to balance capacity or load, or to maintain the persistence and availability of data.

Replicas can specialize as a result of user or administrator expressions of desire for various classes of data protection, offering a storage service for data ranging from temporary and replaceable, to mission critical whose loss may threaten life, revenue or regulatory compliance.

The PDR count described in FIG. 8 represents the minimum number of replicas required for the storage object in order to maintain persistence for the storage object. The PDR count enables the cellular storage system to verify that it has at least a certain number of replicas. It does this by requiring a transactional exchange to occur before a replica may be deleted when the number of replicas is at or near this minimum number, as described in U.S. patent application No. 60/649,259, filed Feb. 1, 2005, to Paul L. Borrill, entitled “Persistent Dynamic Repository”, the disclosure of which is incorporated by reference.

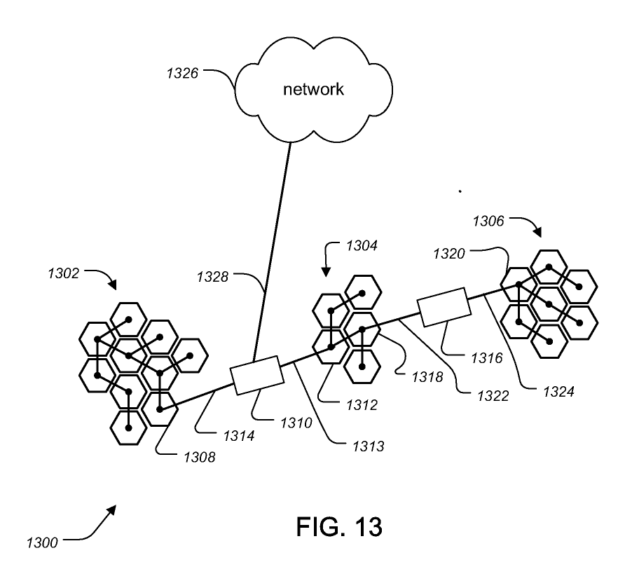

FIG. 13 illustrates a number of cliques 1302, 1304 and 1306 that form a colony 1300. A colony is a set of cliques that exist in relative proximity to a geographical location, e.g., a campus, or set of buildings each of which may contain a single subnet clique.

Collectively, and through an edge cell which acts as a proxy for that clique, the clique 1302 may behave like a cell as it attempts to discover or communicate to other cliques over geographic distances. Each clique can be connected to at least one router by way of an edge cell. Also more than one edge cell can be connected to the same router though only one edge cell will be responsible for the connection to the router at one time. The connection of one clique to another may occur by way of an edge cell 1308 that has a port connection to a router 1310. The edge cell 1308 discovers the router 1310 and performs a rendezvous process as previously described discovering the clique 1304 by way of edge cell 1312. TCP connections 1313 and 1314 can be made between pairs of remote cliques in other geographical locations by way of the router 1310. Clique 1304 can connect to clique 1306 in a similar manner utilizing router 1316, edge cells 1318 and 1320 and TCP connections 1322 and 1324. The connection of cliques forms a colony. The colony may be connected to another colony (not shown here) in a similar way as a clique connects to another clique. The connecting of colonies can form a cellular storage system that can be constrained within a corporate, secured private network or intranet.

A colony can connect to the outside world by way of the router 1310 connecting to a wide area network (WAN) infrastructure 1326 with a TCP connection 1328.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer-readable medium, e.g., a machine-readable storage device, a machine-readable storage medium, a memory device, or a machine-readable propagated signal, for execution by, or to control the operation of, data processing apparatus. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a system having a display device, e.g., a CRT (cathode ray tube) or LCD (liquid crystal display) monitor, for displaying information to the user and a keyboard and a pointing device, e.g., a mouse or a trackball, by which the user can provide input to the system. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The components of the system can be interconnected by any form or medium of digital data communication, e.g., a communication network.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results.

What is claimed is:

1. A system, comprising:
a plurality of substitutable cells, each cell being a self-contained data storage cell storing storage objects and communicating with at least one other cell of the plurality of cells over a data connection between them, there being a path of one or more data connections and zero or more intermediate cells between every cell and every other cell in the plurality of cells;
wherein:
the plurality of cells in the aggregate maintain a plurality of independent cell trees in a distributed way, each node of each cell tree being one cell of the plurality of cells, each branch of each tree being one data connection between a pair of cells, each tree having an initiating cell upon which the tree is grown;
each cell maintains a respective portion of a distributed data structure describing each of the plurality of cell trees by performing substantially the same methods as all of the other cells to build and maintain its respective portion of the distributed data structure; and
each of the plurality of cell trees has a different initiating cell, each initiating cell being one of the plurality of cells, each cell of the plurality of cells is an initiating cell for one of the plurality of cell trees.

2. The system of claim 1, wherein:
the system responds to client requests to create storage objects in the system by creating one or more replicas on cells;
whenever a storage object is initially created in response to a client request on a cell:
the cell uses the cell tree for which the cell is the initiating cell to publish information about the storage object initially created on the cell, and
the cell initiates the building of a handle tree for the storage object, the handle tree being coextensive with and built on the cell tree for the cell; and
whenever a cell in the system performs an operation on an existing storage object, the cell uses the handle tree or a subtree of the handle tree for the storage object to communicate messages to other cells concerning the operation and maintain message order.

3. The system of claim 1, wherein:
each of the plurality of cell trees is a latency-minimized spanning tree spanning the plurality of cells; and
each of the plurality of cells implements substantially the same process for building spanning trees to create the cell trees.

4. The system of claim 1, wherein:
each cell interacts only with reachable cells, reachable cells being cells that a cell can interact with out traversing any other cells.

5. The system of claim 2, wherein:
the plurality of cells maintains a plurality of file trees sets, each file tree set being for a respective particular storage object stored by the system, each file tree set comprising one or more trees superimposed on and co-existent with a base cell tree.

6. The system of claim 5, wherein the file tree set comprises:
the handle tree for the particular storage object, the handle tree being coextensive with the corresponding base cell tree;
a metadata tree for the particular storage object, the metadata tree extending only to cells having metadata for the particular storage object; and
one or more data trees, the one or more data trees being used by the system to manage replicas of the particular storage object.

7. The system of claim 5, wherein the one or more data trees comprise:
a passive file tree, the passive file tree extending only to cells storing replicas of the particular storage object;
a read-only file tree, the read-only file tree extending only to cells storing replicas of the particular storage object that are open at least for reading operations;
a write-invalidate file tree, the write-invalidate file tree extending only to cells storing replicas of the particular storage object that are open at least for write-invalidate operations; and
a write-update file tree, the write-update file tree extending only to cells storing replicas of the particular storage object that are open for write-update operations.

8. The system of claim 1, wherein each data cell has one or more ports, each of which is fully substitutable for connection with other cells and network devices.

9. The system of claim 1, wherein the data connections include one or more direct cable connections, each direct cable connection connecting a port of one cell directly to a port of another cell.

10. The system of claim 1, wherein the data connections include an IP router or switch.

11. The system of claim 1, wherein the cells in the plurality of cells maintain the plurality of trees in self-organizing way.

12. The system of claim 1, wherein none of the cells is a master cell for defining or maintaining the plurality of trees.

13. The system of claim 1, wherein none of the cells maintains all of the information defining any of the plurality of trees.

14. A first storage cell, comprising:
one or more ports for transmitting and receiving data over a data communication link;
a data storage device for storing storage objects;
means for performing start-up operations automatically, the start-up operations comprising operations to:
determine how many other similar storage cells are reachable through each of the one or more ports,
determine whether a router or client device is connected to any of the one or more ports,
identify the first storage cell as an edge cell if a router or a client device is connected to any of the one or more ports and consequently modify operating parameters of the first storage cell to edge cell operating parameters,
identify the first storage cell as a core cell if and only if only similar storage cells are reachable through the one or more data ports and consequently modify operating parameters of the first storage cell to core cell operating parameters, and
initiate the formation of a first cell tree if the first storage cell is an edge cell, the first storage cell being the initiating cell of the first cell tree; and
means for performing replica redundancy operations to maintain storage object persistence in a system including multiple other similar storage cells, the persistence operations comprising operations to:
determine whether a minimum number of replicas of a first storage object appear to exist on the storage cells of the system, and
push a replica of the first storage object to a reachable storage cell if fewer than the minimum number of replicas of a first storage object appear exist on the storage cells of the system by maintaining a distributed count of replicas from the view of each data communication connection radiating out of each cell.

15. A system, comprising:
a plurality of substitutable cells, each cell being a self-contained data storage cell storing storage objects and communicating with at least one other cell of the plurality of cells over a data connection between them, there being a path of one or more data connections and zero or more intermediate cells between every cell and every other cell in the plurality of cells;
a first cell operable to receive client requests to perform operations on a first storage object stored on the system, the first storage object being stored as multiple equivalent and substitutable replicas of the storage object, each replica being stored on a distinct one of the plurality of cells, and no replica being permanently identified a master or authoritative copy of the storage object;
wherein:
when a client connected to a first cell opens the first storage object for writing, a replica of the first storage object is found on or migrated to the first cell and specialized as the replica to be modified by the client, and the other replicas are put in a respective specialized state to prevent inconsistent operations from occurring on the other replicas while the storage object is being written by the client; and
after the client closes the storage object and all changes made to the storage object have propagated successfully to all the replicas of the storage object, all the replicas return to the state of being fully substitutable as replicas of the storage object.

16. The system of claim 15, wherein:
the replica that is identified as the replica to be modified by the client is a replica stored on a cell to which the client has access; and
if no replica exists on the cell to which the client has access, a replica is first created on that cell before the replica to be modified is identified.

17. The system of claim 15, wherein:
the respective specialized state for a first replica is one of the following states:
a state of being synchronously updated as the client modifies the storage object;
a state of being asynchronously updated as the client modifies the storage object; and
a state of being invalid until updated after the client has modified the storage object.

18. The system of claim 15, wherein:
the first cell differentially propagates updates made by the client to the first storage object along a file tree for the first storage object to the other replicas so that other replicas in a first cascaded stage of cells closest to the first cell are sent updates synchronously, other replicas in a second cascaded stage of cells more remote than the first stage are sent updates asynchronously with a high update frequency, and replicas in a third cascaded stage of cells more remote than the second stage are sent invalidates to invalidate the replicas or are sent updates with a lower update frequency.

19. A system, comprising:
a plurality of substitutable cells, each cell being a self-contained data storage cell storing storage objects and communicating with at least one other cell of the plurality of cells over a data connection between them, there being a path of one or more data connections and zero or more intermediate cells between every cell and every other cell in the plurality of cells;
each cell having a low threshold and a high threshold, the cell offering storage capacity to the rest of the system if its use of storage capacity is below the low threshold, the cell attempting to move replicas to the rest of the system if its use of storage capacity is above the high threshold; and
each cell being able to adjust its thresholds by time of day or adaptively in response to traffic monitoring on the network.

20. A system, comprising:
a plurality of substitutable cells, each cell being a self-contained data storage cell storing storage objects and communicating with at least one other cell of the plurality of cells over a data connection between them, there being a path of one or more data connections and zero or more intermediate cells between every cell and every other cell in the plurality of cells;
wherein:
each of the plurality of cells is reachable from only a limited number of other cells, a cell being reachable from another cell when there is a connection between the two cells that does not traverse a third cell;
each of the cells of the plurality of cells is substitutable for each of the other cells in forming the system;
each of the cells has multiple communication ports and each cell is connected to each of the other cells through one of the communication ports of the respective cells, and each of the communication ports on each cell is substitutable in forming connections with each of the other communication ports of the cell;
the cells cooperate in a self-organizing way to form cell trees spanning the plurality of cells; and
each of the cells implements a resource management process that operates autonomously in each cell and causes multiple cells to cooperate to migrate storage object replicas from cells in which storage resources are relatively more scarce to cells in which storage resources are relatively less scarce, the resource competition process on each cell using the spanning trees to determine directions in which to move replicas.

21. The system of claim 20, wherein the resource management process further operates autonomously in each cell and causes multiple cells to cooperate to migrate storage object replicas to cells that are distant in latency from each other.

22. The system of claim 20, wherein the cell trees are latency-minimized spanning trees.

23. The system of claim 20, wherein each of the plurality of cells has a deliberately restricted number of active links to other cells to encourage the emergence of self-organizing behavior in the resultant system.
